(19) United States
(12) Patent Application Publication
(10) Pub. No.: US 2002/0046156 A1
(43) Pub. Date: Apr. 18, 2002

(54) Apparatus, methods and articles of manufacture for executing computerized transaction processes

(75) Inventors: Steven B. Horn, New York, NY (US); John Tumilty, New York, NY (US)

Correspondence Address: DILWORTH PAXSON LLP, 3200 MELLON BANK CENTER, 1735 MARKET STREET, PHILADELPHIA, PA, 19103, US

(73) Assignee: Goldman, Sachs & Company, New York, NY (US)

(21) Appl. No.: 09/942,454

(22) Filed: Aug. 30, 2001

Related U.S. Application Data
(63) Continuation-in-part of application No. 09/823,125, filed on Mar. 30, 2001.
Application No. 09/823,125 is a continuation-in-part of application No. 09/773,139, filed on Jan. 31, 2001.
(60) Provisional application No. 60/241,807, filed on Oct. 14, 2000.

(51) Int. Cl. G06F 17/60

(52) U.S. Cl. 705/37

(57) ABSTRACT

Apparatus, methods and articles of manufacture for construction and execution of computerized transaction processes comprising one or more Order Management Systems in a distributed computing environment. The various embodiments construct the Order Management System from of cooperating service components, an in memory cache, and a client API. Use of a toolkit of these components provides an ability to customize an Order Management System.

### CROSS-REFERENCE TO RELATED APPLICATIONS

This application is a continuation-in-part of U.S. application Ser. No. 09/823,125, entitled “APPARATUS, METHODS AND ARTICLES OF MANUFACTURE FOR CONSTRUCTING AND EXECUTING COMPUTERIZED TRANSACTION PROCESSES AND PROGRAMS”, filed on Mar. 30, 2001, by Hernan G. Otero, Steven B. Horn and John Tumilty, which disclosure is incorporated herein by reference.

### FIELD OF THE INVENTION

This invention relates to apparatus, methods and articles of manufacture for computerized transaction execution and processing. More particularly, this invention relates to apparatus, methods and articles of manufacture for client-server transaction execution and processing.

### BACKGROUND OF THE INVENTION

Transaction execution and processing usually requires sophisticated and customized computer systems. The subset of transaction execution and processing computer systems used in financial instrument trading are often even more complex, as these systems usually need to accept input from other systems as well as format output acceptable to other systems. These input and output needs mean that input and output must proceeds according to specific formatting conventions, and systems designed to execute and process transactions should recognize those specific conventions.

Moreover, input and output may be across a number of other platforms and/or networks, including internal platforms and/or networks (if the systems are used within an enterprise), as well as external platforms and/or networks. These platforms and/or networks could exist presently as well as be created in some future time. Any input and output must usually also be secure, thus adding additional elements of complexity.

The need for complexity is often countered by the need for flexible and customizable implementation. Flexible and customizable implementation permits ease of use and implementation in any given existing environment, as well as implementation in future environments, yet more complex systems may not be sufficiently customizable to make them practically useful.

Time, or execution speed, is also a factor in the design of such systems. Trading systems must usually execute and process transactions rapidly, especially when deployed in the area of trading financial instruments. Financial instruments transactions and processing involve values that may change from moment to moment, and any system implemented in this area must recognize the time sensitive nature of these financial transactions.

Enterprise-wide customization adds yet another level of time, effort and complexity. What may be useful in one enterprise business unit may not be useful in another, and time, effort and resources may not be available to implement specific programs customized for each business unit.

Finally, any implementations must be quite robust, and reliably and consistently execute trading strategies. The implementation of new computerized transactional programs must be as close to bullet proof as possible—failure of a trading program can mean losses in thousands, millions or even billions of dollars.

One specific area of interest to computerized transactional programs is the area of Order Management. In financial instrument trading, Order Management may be understood as communication taking place among two or more parties during a transaction. The communication may be simple, such as when a Customer instruct a Salesperson to purchase “One hundred shares of Microsoft,” and the order passes to simple execution from a firm's internal inventory; or the communication may be more complex, as when a trader uses an algorithm such as Volume-Weighted-Average-Price or VWAP to trader on numerous exchanges throughout the day. Thus, it would be most desirable to have a computerized Order Management Network or System that aids communication among parties to a transaction. It would be even more desirable to have a computerized Order Management Network or System that enables quick, secure, robust and reliable communication among parties to a transaction, as well as among systems involved in a transaction. It would also be desirable that any such system be sufficiently flexible or customizable so as to allow communications to and from existing and future internal and external trading systems.

Accordingly, it is an object of this invention to provide apparatus, methods and articles of manufacture for constructing and executing transactions.

It is a further object of this invention to provide secure, customizable, fast, robust and reliable apparatus, methods and articles of manufacture for executing and processing financial instrument trading.

It is yet a further object of the present invention to have an computerized Order Management Network or System that aids in communication among parties to a transaction and systems involved in a transaction.

It is yet a further object of the present invention to have a computerized Order Management Network or System that enables quick, secure, robust, reliable, flexible and customizable communication among parties to a transaction and systems involved in the transaction.

### BRIEF DESCRIPTION OF THE DRAWINGS

FIG. 1 shows a schematic diagram of a preferred embodiment.

FIG. 2 shows a schematic diagram of a preferred embodiment.

FIG. 3 shows a schematic diagram of a preferred embodiment.

### SUMMARY OF THE INVENTION

The present invention provides apparatus, methods and articles of manufacture for construction and execution of computerized transaction processes. In the preferred embodiments, an architecture or toolkit of preferred components is used to permit the construction of customized systems. These customized systems can then be used in turn to implement computerized trading systems which manage and process transactions, including but not limited to orders and execution of orders in a trading environment or environments.

In the especially preferred embodiments, transaction management includes, but is not limited to, processing of an order through an exchange or exchanges. Transaction processing includes, but is not limited to, order processing. Order processing may include, but is not limited to providing complex orders to a system or systems for deconstruction as well as breaking down complex orders into simple orders for execution, as well as order execution.

Also the especially preferred embodiments are implemented in a distributed processing environment, thus providing greater reliability and fault tolerance.

### DETAILED DESCRIPTION OF THE PREFERRED EMBODIMENTS

The preferred embodiments of the present invention provide apparatus, methods and articles of manufacture to implement computerized trading systems which manage and process transactions in a trading environment or environments. In the preferred embodiments, an architecture or toolkit of preferred components is used to permit the construction of these customized Order Management Systems (OMS.) Thus, in the preferred embodiments, OMS's may be processing and managing orders with regard to Customers, the Sales Desk, Trading Desks, and/or Exchanges, and thus assure order flow between and among those parties. An integrated network of systems (an Order Management Network or OMN) to support electronic order flow or management may also be implemented, comprised of one or more OMS's.

The preferred embodiments are comprised of components written primarily in C++. Certain components may be assembled from preexisting tools and libraries such as the Rogue Wave collection of tools and libraries. C++ permits cross platform implementation to a great extent, which may be especially helpful if embodiments are implemented in a distributed computing environment. Of course, other embodiments may be translated into other languages. Therefore, the embodiments may be used across a wide variety of platforms.

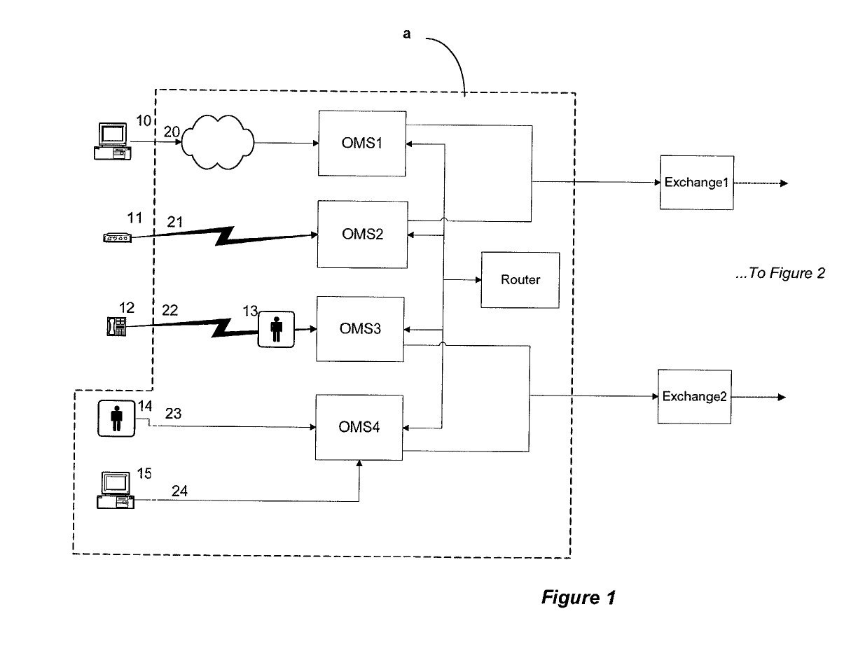

FIG. 1 shows a schematic diagram of a preferred embodiment in place in a trading environment, located largely within an enterprise shown generally at a. The OMN is an integrated network of systems to support electronic order flow, and comprises, in this embodiment, a number of OMS's as is explained further below.

The external trading parties, such as Customers, are shown outside the dotted line of the enterprise, and the internal trading parties, such as traders within the enterprise, are shown within the dotted line. Among the inputs and output from the parties are: Customer1 (10) trading by computer via the Internet, Customer2, (11) trading via a direct modem link, Customer3 (12) trading via a telephone connection to a Sales person (not shown); Trader1 (14) trading through an internal link, and Computerized Trading Program (15). Of course, in other embodiments, these parties may be different parties, be different in number, etc.

Each Order executed by each party is shown in the Figure as follows: Customer1 places Order 20, Customer2 places Order 2, Customer3 places Order 22, Trader1 places Order 23, and Computerized Trading Program places Order 24. The Orders pass through respective routing mechanisms not shown. In other embodiments, Order routing may take place in any number of ways known in the art.

From the routing mechanisms, the orders pass to an Order Management System or OMS. In the Figure, for descriptiveness, each Order is shown passing from a routing mechanism to a linked OMS. In other embodiments, the architecture of the routing may be different, for example, one or more of the routing mechanisms may feed to the same OMS, there may be no routing mechanism, etc.

Orders are processed through the various OMS's as is explained in further detail below. Before detailing the processing however, it might be helpful to understand Order flow, assuming all Orders entered are executed and pass through one or more Exchanges. Of course, Order processing also, in the preferred embodiments, processes Orders that are not executed, through communication failures, etc. In general, the term transaction information includes but is not limited to Order information such as execution information as well as non executed order information.

As can be seen in FIG. 1, Orders pass from an OMS to an Exchange by way of a direct link, such as in known in the art. Routing of Orders and any other exchanges between various OMS's occurs by way of a global Router. The addressing mechanism is established by the various OMS's.

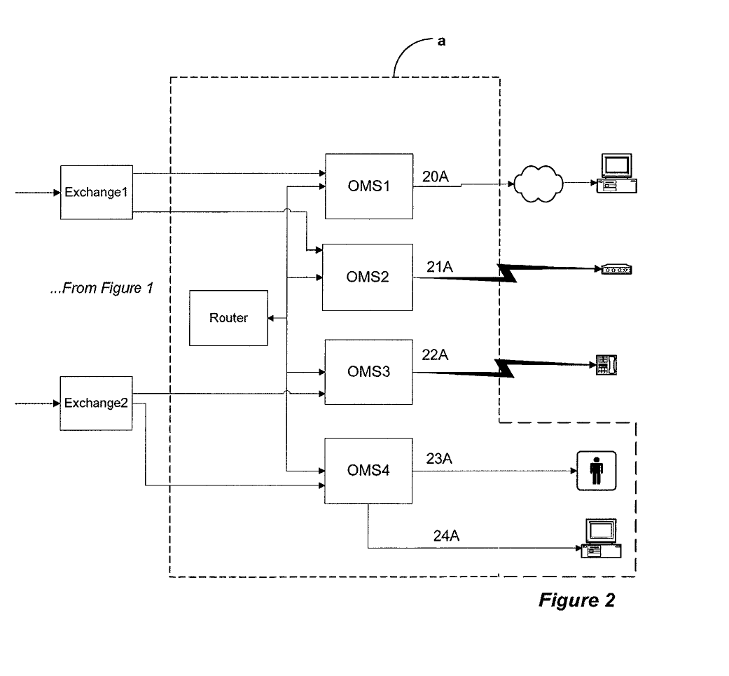

Turning now to FIG. 2, and assuming the Exchanges have executed the order, the execution notifications (now identified with their respective Orders by way of an “A” suffix) will pass from the Exchanges directly to the OMS's, and from there ultimately to the appropriate parties. Any Routing of Orders and any other exchanges between various OMS's occurs by way of a global Router.

It should be noted that the OMN depicted in FIGS. 1 and 2, and Order flow as depicted herein is not the sole or a sole possible OMN, or the sole or a sole possible Order flow, but is only that of a preferred embodiment. In this embodiment and other preferred embodiments, order processing may be made more secure and robust. The various OMS's receive orders, and process those orders, discretely, so that system outages in other areas, such as for example, exchange failures, have limited impact on order processing. If, for example, the exchange or exchanges are unavailable, orders will continue to be processed through the OMS's, and new orders can enter the OMS's, while awaiting the outage resolution.

The preferred embodiment comprises a number of core components, available as a toolkit to construct specific OMS implementations. These core components consist of: a set of cooperating services which, in the especially preferred embodiments are implemented in a distributed computing environment; an in-memory cache, which can greatly assist performance, and, in the especially preferred embodiments may be implemented by ways of preexisting caching technology such as that from Persistence; one or more client API's, which may be open ended, that is, for existing and future interfaces; integration with internal enterprise product databases, which contain the details on various financial instruments, and which may be open ended interfaces, that is, may be modified as desired for existing and future databases; security and authorization components; as well as multi-threaded implementation.

By using open ended interfaces, the system may be linked as desired and is not dependant on one or more existing links or databases. For example, as the OMS's described above with respect to FIGS. 1 and 2 illustrate, the interfaces are to the Exchanges and a global Router, and can be written using methods known in the art.

The toolkit of the preferred embodiments may be used in various ways to implement various OMS's, and build one or more OMN's. In the especially preferred embodiments, one or more OMS's, appropriately constructed via the toolkit of the preferred embodiments, is used to provide services to one or more order processing systems, which may be used in assisting traders to execute complex orders such as trading algorithms. Such an order processing system is disclosed in co-pending U.S. application Ser. No. 09/823,125, entitled “APPARATUS, METHODS AND ARTICLES OF MANUFACTURE FOR CONSTRUCTING AND EXECUTING COMPUTERIZED TRANSACTION PROCESSES AND PROGRAMS”, filed on Mar. 30, 2001, by Hernan G. Otero, Steven B. Horn and John Tumilty, incorporated herein by reference.

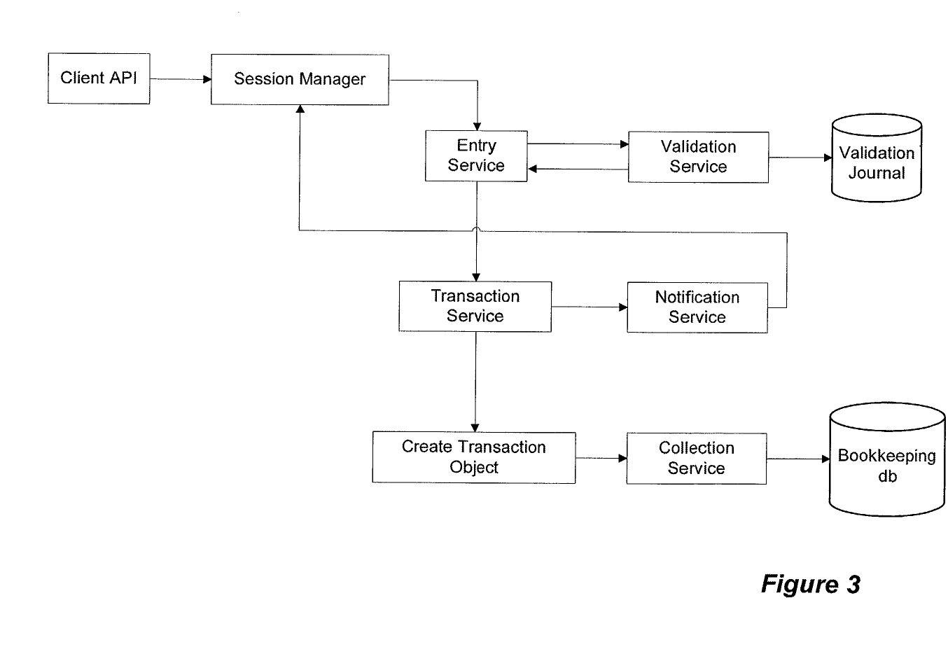

Turning now to FIG. 3, flow through an preferred OMS embodiment is seen. A new Order is sent to a server or server where the Session Manager resides. The Session Manager may, in the preferred embodiments, reside on one or more systems, and so in the preferred embodiments it is written in Orbix, which is an implementation of the Common Object Request Broker Architecture (CORBA), used in distributed processing environments. The Order is sent to Session Manager by a Client API. Of course, in other embodiments, the Order may be sent to the server, or received by the server, by any method known in the art.

Each order obtains a session in the preferred embodiments, which assists in overall stability and verification of the order. From the Session Manager (operating at the Communications layer) the Order passes to the Entry Service for Validation. Validation includes here the process of ensuring the Order is in the proper format for subsequent order processing and is performed by the Validation Service. Validated Orders are also stored in a journal in order to provide recovery ability for the system.

Once the Validation Service notifies the Entry Service that the Order is as it should be, the Entry Service passes the Order to the Transaction Service, which determines how to apply the Order, and creates an appropriate Object for further processing. In order to perform its function, the Transaction Service monitors the system state. So, for example, if an order is of a type unavailable to the system, such as an Order when the exchange is not available, the Transaction Service will create an appropriate Order object. As another example, the Order may be an initial Order, as for example, Order 20 of FIG. 1, the Transaction may be an execution, as for example 20A of FIG. 2, etc. In the example of Order 20, the Transaction Service will create an Order Object, in the example of Execution 20A, an appropriate Execution Object, etc. This Object is then passed to the Collection Service, which is, in this embodiment, an in-memory database containing orders, their executions and their history. The scope of the database can be as desired, that it, it can contain orders for a predetermined time period. The Collection Service also journals an order for later recovery, if necessary, in a Bookkeeping database.

The Transaction Service also sends the Object to the Notification service which determines which clients are to be notified of the order. The Notification Service decides who to notify, in the preferred embodiments, by determining which clients have registered for orders which interest the client. When an order is received by the Notification Service, the service will review or iterate through the registered client information and use that as its notification indicators. The Notification Service then passes the appropriate order information is then passed back to the Session Manger, which sends the order to the appropriate parties.

Other embodiments of the present invention may be used to build OMS's singly, as part of an OMN, or an OMN. Those other embodiments may use toolkits with preexisting components, so as to simplify construction; toolkits with preexisting groups of components, such as a toolkit only used for constructing Client-side OMS'S with appropriate API's; toolkits with preexisting interfaces to exchanges, routing mechanisms, and/or other inputs and outputs. Moreover, one or more orders may be generated from a single order through various other systems which input and/or output to one or more OMS's, and components of embodiments such as the Transaction Service may be suitably modified to process orders resulting from such input and/or output.

Accordingly, the above description and the views and material depicted by the figures are for purposes of illustration only and are not intended to be, and should not be construed as, limitations on the invention.

Moreover, certain modifications or alternatives may suggest themselves to those skilled in the art upon reading of this specification, all of which are intended to be within the spirit and scope of the present invention as defined in the attached claims.

We claim:

1. A method for transaction management and processing in a trading environment comprising:
providing an Order Management System for receiving Orders;
processing Orders, by way of said Order Management System, whereby processing Orders further comprising the steps of;
providing Orders from an Order Management System to an Exchange; and,
providing transaction information for Orders from an Exchange to an Order Management System; and
whereby said Order Management System comprises components selected from the group comprising; at least two cooperating services, in-memory cache, and client API.

2. A method as in claim 1 wherein the step of providing an Order Management System for receiving Orders further comprises providing said Order Management System in a distributed computing environment.

3. A method as in claim 1 wherein the step of providing an Order Management System for receiving Orders further comprises providing said Order Management System in a multi-threaded implementation.

4. A method as in claim 1 wherein said components are, at least in part, written in C++.

5. A method for order processing comprising;
accepting an Order through a client API;
providing, from said client API, said Order to a Session Manager;
providing a session for said Order;
transmitting said Order from said Session Manager to an Entry Service; and,
attempting to Validate said Order through a Validation Service.

6. A method as in claim 5 further comprising the step of failing to Validate said Order.

7. A method as in claim 5 further comprising the steps of:
validating said Order;
notifying an Entry Service through said Validation Service;
transmitting said Order from said Entry Service to a Transaction Service; and
creating an Object for said Order.

8. A method as in claim 7 wherein the step of creating an Object for said Order comprises creating an Order Object.

9. A method as in claim 7 wherein the step of creating an Object for said Order comprises creating an Execution Object.

10. A method as in claim 7 further comprising the steps of:
transmitting said Object to a Collection Service;
transmitting said Object to a Notification Service; and,
transmitting said Order to a Client API.

11. The Object of claim 7.

12. The Order Object of claim 8.

13. The Execution Object of claim 9.

14. A method for constructing an Order Management System comprising:
implementing at least two cooperating services components;
implementing an in-memory cache component, and
implementing a client API, for use on a distributed computing platform.

15. An Order Management System comprising at least two cooperating services, an in-memory cache, and a client API, implemented on a distributed computing platform.

16. An Order Management Network comprised of at least one Order Management System.

17. A toolkit for constructing an Order Management System comprising cooperating services components, in-memory cache components, and a client API.

18. A toolkit as in claim 17, wherein said cooperating services components further comprise; a Session Manager; an Entry Service; a Validation Service; a Transaction Service; a Collection Service; and a Notification Service.

19. A toolkit as in claim 17 wherein said cooperating service components are written, at least in part, in C++.
